(19) United States
(12) Patent Application Publication
(10) Pub. No.: US 2015/0015987 A1
(43) Pub. Date: Jan. 15, 2015

(54) Prioritized Spin-Up of Drives

(71) Applicant: LSI Corporation, San Jose, CA (US)

(72) Inventors: Naveen Krishnamurthy, Bangalore (IN); Naresh Madhusudana, Bangalore (IN)

(73) Assignee: LSI Corporation, San Jose, CA (US)

(21) Appl. No.: 13/953,062

(22) Filed: Jul. 29, 2013

(30) Foreign Application Priority Data
Jul. 10, 2013 (IN) 818KOL2013

(51) Int. Cl. G11B 19/20

(52) U.S. Cl. CPC G11B 19/209
USPC 360/73.02

(57) ABSTRACT

A data storage system controller designates critical drives for staggered spin up and other, non-critical drives for spin up only when the controller notifies the appropriate expander. Each expander in the data storage system maintains configuration information for each PHY of the expander and reports completion of spin up when all of the drives designated “staggered spin up” have been spun up. Alternatively, an expander maintains PHY configuration data, designating each PHY as “staggered spin up,” “host notify” or “disabled.” At boot time, only devices connected to PHYs designated “staggered spin up” are spun up in cycles before reporting spin up completion to a host device.

### PRIORITY

The present application claims the benefit under 35 U.S.C. §119(a) of Indian Patent Application Serial Number 818/KOL/2013, filed Jul. 10, 2013, which is incorporated herein by reference.

### BACKGROUND OF THE INVENTION

In a redundant array of independent discs (RAID) storage system with large numbers of drives, the use of expanders is inevitable. Expanders spin up the drives during power up. If all the drives were spun up simultaneously the resulting power draw would overload the available power supply. To overcome this issue, expanders perform staggered spin up where predefined sets of drives are spun up in cycles until all drives are spun up. Multiple such cycles are required to spin up all the drives, and all the drives need to be spun up before reporting the completion of spin up because drive usage is completely hidden from the expander; the controller is the device that communicates with the user/operating system and designates drive usage.

Consequently, it would be advantageous if an apparatus existed that is suitable for prioritizing spin up in a data storage system according to the designated usage of connected drives.

### SUMMARY OF THE INVENTION

Accordingly, the present invention is directed to a novel method and apparatus for prioritizing spin up in a data storage system according to the designated usage of connected drives.

In at least one embodiment of the present invention, a data storage system controller designates critical drives for staggered spin up and other, non-critical drives for spin up only when the controller notifies the appropriate expander. Each expander in the data storage system maintains configuration information for each PHY of the expander and reports completion of spin up when all of the drives designated “staggered spin up” have been spun up.

In another embodiment of the present invention, an expander maintains PHY configuration data, designating each PHY as “staggered spin up,” “host notify” or “disabled.” At boot time, only devices connected to PHYs designated “staggered spin up” are spun up in cycles before reporting spin up completion to a host device. Devices connected to PHYs designated “staggered spin up” could include drives that are part of a redundant array of independent discs, or drives that contain the host operating system. Furthermore, devices connected to PHYs designated “disabled” could include operable devices that may be used as hot spares if necessary, and failed devices that have not yet been removed from the system.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows a block diagram of an expander according to at least one embodiment of the present invention;

FIG. 2 shows a block diagram of a data storage system including three expanders and a controller;

FIG. 3 shows a block diagram of a data storage system including three expanders and a controller according to at least one embodiment of the present invention;

FIG. 4 shows a flowchart of a method for configuring a data storage system including components according to at least one embodiment of the present invention;

FIG. 5 shows a flowchart of another method for configuring a data storage system including components according to at least one embodiment of the present invention;

FIG. 6 shows a flowchart of another method for configuring a data storage system including components according to at least one embodiment of the present invention;

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

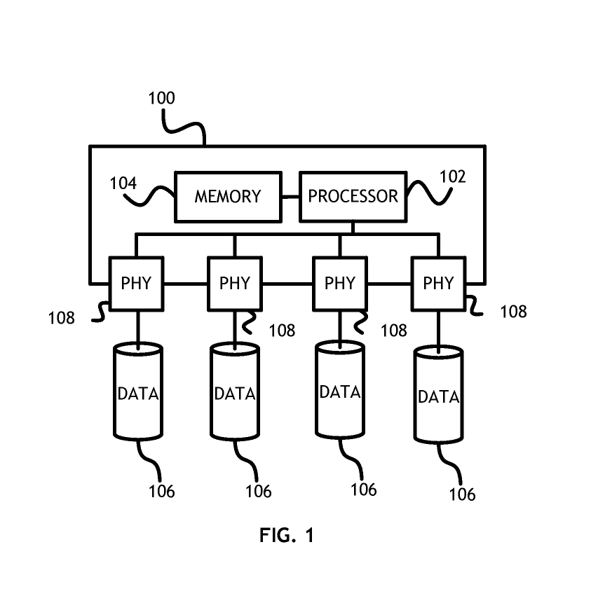

Referring to FIG. 1, a block diagram of an expander according to at least one embodiment of the present invention is shown. In at least one embodiment of the present invention, an expander 100 includes a processor 102 and a memory 104 connected to the processor 102. The processor 102 is connected to a plurality of PHYs 108, each PHY 108 configured to connect to a device such as a hard disk drive 106. The processor 102 receives input/output commands from an external controller and relays such command to an appropriate device 106 through the corresponding PHY 108.

The memory 104 stores PHY configuration information associated with each of the PHYs 108, designated the spin up priority of the device 106 connected to each PHY 108. In at least one embodiment, PHYs 108 are designated “staggered spin up,” “host notify” or “disabled.”

At boot time, when the expander 100 receives an instruction to begin spinning up connected devices, the processor 102 identifies all PHYs 108 designated “staggered spin up” and begins spinning up the devices 106 attached to those PHYs 108 according to some predetermined priority schedule to avoid overloading the expander power supply. When all of the devices 106 attached to PHYs 108 designated “staggered spin up” have been spun up, the processor 102 sends a signal to a controller indicating spin up is complete, even though less than all of the attached devices have spun up. The expander 100 thereby improves boot up time and system availability by allowing a controller to communicate with devices 106 more rapidly after boot up.

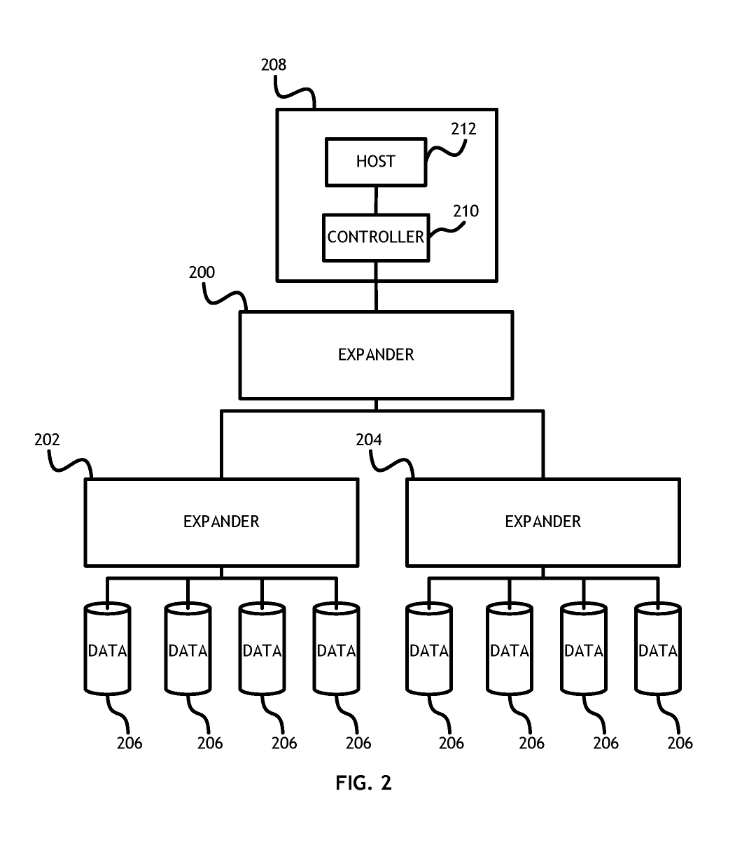

Referring to FIG. 2, a block diagram of a data storage system including three expanders and a controller is shown. In at least one embodiment of the present invention, a server 208 includes a processor executing a host 212 process, connected to a controller 210 configured to communicate with one or more expanders 200, 202, 204. Each expander 200, 202, 204 is configured to route input/output requests to and from connected devices 206 or other expanders 200, 202, 204. For example, a first expander 200 is connected directly to the controller 210 and to a second expander 202 and a third expander 204. Each of the second expander 202 and third expander 204 is connected to a plurality of devices 206 such as hard disk drives. When the server 208 receives an input/output request, the host 212 forwards such request to the controller 210 which will instruct the expanders 200, 202, 204 accordingly.

In a redundant array of independent discs storage system, devices 206 connected to the expanders 200, 202, 204 may organized into one data storage volume, and the individual devices are substantially invisible to the end user. Because of the nature of such storage systems, input/output operations cannot be processed until all of the devices 206 comprising the redundant array of independent discs are spun up and operable. However, each of the expanders 200, 202, 204 is unaware of which devices 206 comprise the redundant array of independent discs and which devices 206 comprise spare capacity. The controller, however, is aware which devices 206 are actually necessary to process input/output operations.

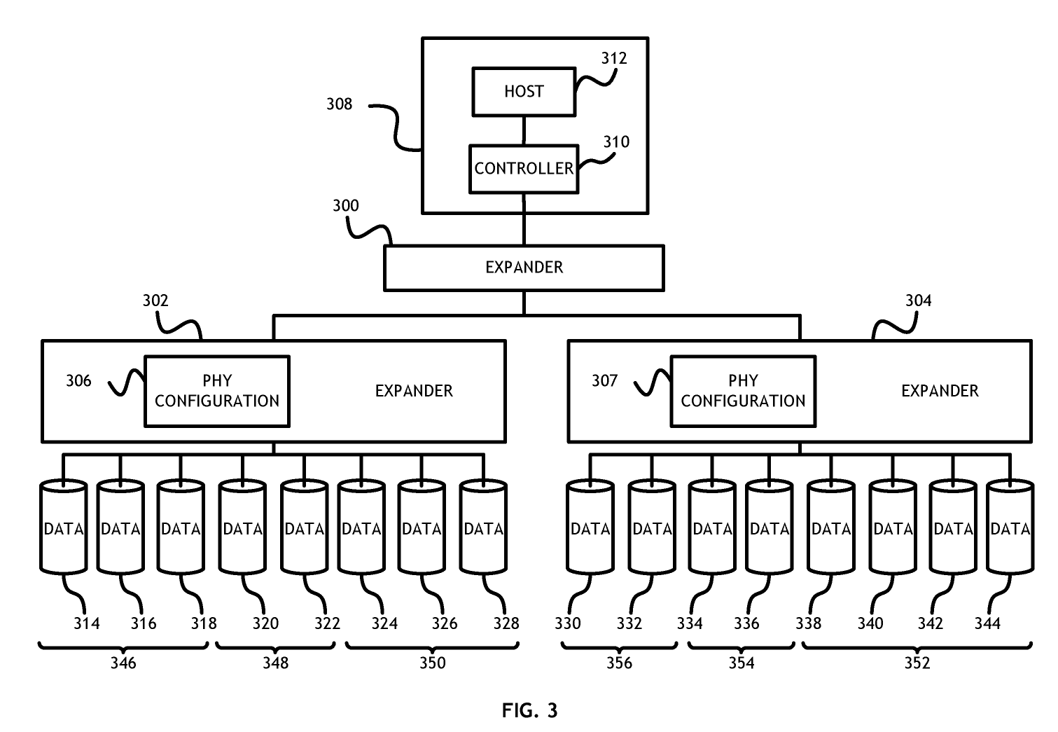

Referring to FIG. 3, a block diagram of a data storage system including three expanders and a controller according to at least one embodiment of the present invention is shown. In at least one embodiment of the present invention, a server 308 includes a processor executing a host 312 process, connected to a controller 310 configured to communicate with one or more expanders 300, 302, 304. Each expander 300, 302, 304 is configured to route input/output requests to and from connected devices 314, 316, 318, 320, 322, 324, 326, 328, 330, 332, 334, 336, 338, 340, 342, 344 or other expanders 300, 302, 304. For example, a first expander 300 is connected directly to the controller 310 and to a second expander 302 and a third expander 304. Each of the second expander 302 and third expander 304 is connected to a plurality of devices 314, 316, 318, 320, 322, 324, 326, 328, 330, 332, 334, 336, 338, 340, 342, 344 or other expanders 300, 302, 304 such as hard disk drives. When the server 308 receives an input/output request, the host 312 forwards such request to the controller 310 which will instruct the expanders 300, 302, 304 accordingly.

Where the plurality of devices 314, 316, 318, 320, 322, 324, 326, 328, 330, 332, 334, 336, 338, 340, 342, 344 comprise a redundant array of independent discs, such that two or more of the devices 314, 316, 318, 320, 322, 324, 326, 328, 330, 332, 334, 336, 338, 340, 342, 344 are treated as a single data storage volume, the host 312 cannot process input/output requests until all of the devices 314, 316, 318, 320, 322, 324, 326, 328, 330, 332, 334, 336, 338, 340, 342, 344 comprising the redundant array of independent discs is spun up. However, devices 314, 316, 318, 320, 322, 324, 326, 328, 330, 332, 334, 336, 338, 340, 342, 344 comprising hot spares or otherwise unused drives are not necessary to process input/output requests.

When a redundant array of independent discs is initially established, the controller 310 may identify which devices 314, 316, 318, 320, 322, 324, 326, 328, 330, 332, 334, 336, 338, 340, 342, 344 will comprise portions of the storage volume, which will comprise hot spares and which will remain unutilized in anticipation of additional capacity needs. For example, the controller 310 can designate a first set 346 of devices 314, 316, 318 connected to the second expander 302 and a first set 352 of devices 338, 340, 342, 344 connected to the third expander 304 as part of a redundant array of independent discs. Those redundant array devices 314, 316, 318, 338, 340, 342, 344 must be spun up before the host 312 can begin servicing input/output requests. The controller 310 can also designate a second set 348 of devices 320, 322 connected to the second expander 302 and a second set 354 of devices 334, 336, 338 connected to the third expander 304 as hot spares. Hot spare devices 320, 322, 334, 336, 338 do not need to be spun up before the host 312 can begin servicing input/output requests but do need to be quickly available in the event of a disc failure. Finally, the controller 310 can designate a third set 350 of devices 324, 326, 328 connected to the second expander 302 and a third set 356 of devices 330, 332 connected to the third expander 304 as unconfigured or offline. Unconfigured devices 324, 326, 328, 330, 332 are initially unused and may be added to the redundant array of independent discs as more capacity becomes necessary; or they may be utilized as new hot spares as hot spare devices 320, 322, 334, 336, 338 are utilized. Unconfigured devices 324, 326, 328, 330, 332 do not need to be spun up before the host 312 can begin servicing input/output requests.

Once the controller 310 determines an initial configuration for the data storage system topology, the function of each device 314, 316, 318, 320, 322, 324, 326, 328, 330, 332, 334, 336, 338, 340, 342, 344 is communicated to the corresponding expander 300, 302, 304. Each expander 300, 302, 304 then produces and stores a data structure correlating each PHY in the expander 300, 302, 304 with the designation of the device 314, 316, 318, 320, 322, 324, 326, 328, 330, 332, 334, 336, 338, 340, 342, 344 connected to that PHY.

Continuing the previous example, the second expander 302 includes a PHY configuration data structure 306 storing PHY configuration information for the devices 314, 316, 318, 320, 322, 324, 326, 328 connected to the second expander 302. In at least one embodiment, the first set 346 is designated “staggered spin up.” Such designation is stored in the PHY configuration data structure 306. Staggered spin up indicates to the expander 302 that such devices 314, 316, 318 should be spun up at boot time. Where the first set 346 designated staggered spin up includes more devices 314, 316, 318 than can be spun up in a single cycle, the expander 302 spins up the devices 314, 316, 318 according to some predetermined priority rule such as spinning up devices 314, 316, 318 according to the sequence of the connecting PHY or any other appropriate priority sequencing.

In at least one embodiment, the second set 348 is designated “host notify.” Such designation is stored in the PHY configuration data structure 306. Host notify indicates to the expander 302 that such devices 320, 322 should be spun up only when the host issue an appropriate command, and not at boot time. Where the second set 348 is designated host notify, the expander 302 does not wait for such devices 320, 322 to spin up at boot time before reporting to the controller 310 that spin up is complete.

In at least one embodiment, the third set 350 is designated “disabled.” Such designation is stored in the PHY configuration data structure 306. Disabled indicates to the expander 302 that such devices 324, 326, 328 should be disabled and require some change in designation before spin up can occur. Where the third set 350 is designated disabled, the expander 302 does not wait for such devices 324, 326, 328 to spin up at boot time before reporting to the controller 310 that spin up is complete.

Similarly, the third expander 304 includes a PHY configuration data structure 307 storing PHY configuration information for the devices 330, 332, 334, 336, 338, 340, 342, 344 connected to the third expander 304. In at least one embodiment, the first set 346 is designated “staggered spin up.” Such designation is stored in the PHY configuration data structure 307. Staggered spin up indicates to the expander 304 that such devices 338, 340, 342, 344 should be spun up at boot time. Where the first set 346 designated staggered spin up includes more devices 338, 340, 342, 344 than can be spun up in a single cycle, the expander 304 spins up the devices 338, 340, 342, 344 according to some predetermined priority rule such as spinning up devices 338, 340, 342, 344 according to the sequence of the connecting PHY or any other appropriate priority sequencing.

In at least one embodiment, the second set 348 is designated “host notify.” Such designation is stored in the PHY configuration data structure 307. Host notify indicates to the expander 304 that such devices 334, 336 should be spun up only when the host issue an appropriate command, and not at boot time. Where the second set 348 is designated host notify, the expander 304 does not wait for such devices 334, 336 to spin up at boot time before reporting to the controller 310 that spin up is complete.

In at least one embodiment, the third set 350 is designated “disabled.” Such designation is stored in the PHY configuration data structure 307. Disabled indicates to the expander 304 that such devices 330, 332 should be disabled and require some change in designation before spin up can occur. Where the third set 350 is designated disabled, the expander 304 does not wait for such devices 330, 332 to spin up at boot time before reporting to the controller 310 that spin up is complete.

At boot time, each of the second expander 302 and third expander 304 receives a boot signal from the controller 310, reads its corresponding PHY configuration data structure 306, 307 and spins up all devices 314, 316, 318, 338, 340, 342, 344 connected to PHYs designated “staggered spin up.” Where necessary, spin up occurs according to a staggered spin up schedule defined by each expander 302, 304. Each expander 302, 304 then reports spin up complete to the controller 310. Devices 320, 322, 324, 326, 328, 330, 332, 334, 336 connected to PHYs designated “host notify” or “disabled” are not spun up at this time.

In another exemplary embodiment, the host 312 operating system is stored on one or more devices 314, 316, 318, 320, 322, 324, 326, 328, 330, 332, 334, 336, 338, 340, 342, 344 connected to one of the expanders 302, 304. For example, the host 312 operating system stored on a third set 356 of devices 330, 332 connected to the third expander 304. Because the host 312 operating system is critical to the operation of the host 312, the third set 356 must be spun up at boot time before any other operations can be performed. The third set 356 is therefore designated “staggered spin up.” At boot time, the third set 356 containing the host 312 operation system is spun up and the third expander reports spin up complete to the controller 310. The host 312 then boots up.

In order to minimize the time to boot up the host 312, it is advantageous for the third expander 304 to report spin up complete as soon as the third set 356 is spun up; therefore, only the third set 356 is designated staggered spin up in the PHY configuration data structures 306, 307. Other devices 314, 316, 318, 320, 322, 324, 326, 328, 334, 336, 338, 340, 342, 344 are connected to PHYs designated either “host notify” or “disabled.” For example, there the first set 346 connected to the second expander 302 and the first set 352 connected to the third expander 304 are previously designated to comprise a redundant array of independent discs, the PHYs corresponding to such sets 346, 352 are designated “host notify.” After the host 312 has booted up, the controller 310 sends appropriate commands to instruct the second expander 302 and third expander 304 to spin up devices 314, 316, 318, 338, 340, 342, 344 comprising the redundant array of independent discs. In one embodiment, the controller 310 determines an acceptable spin up sequence; in another embodiment, each expander 302, 304 determines a spin up sequence where the number of spin up commands received from the controller 310 would exceed the available power supply.

During normal operation, a controller 310 can change the designation of a PHY in a PHY configuration data structure 306, 307. For example, where a second set 348 in the second expander 302 is designated “host notify,” and comprises devices 320, 322 operating as hot spares, one of the devices 320, 322 may be activated to compensate for some other failed device. In that case, the PHY connected to the newly activated device 320 is re-designated “staggered spin up.” Furthermore, the PHY connected to the failed device 316 is re-designated “disabled.” Also, a PHY connected to an operable but disabled device 324 is re-designated “host notify” in anticipation of use as a hot spare.

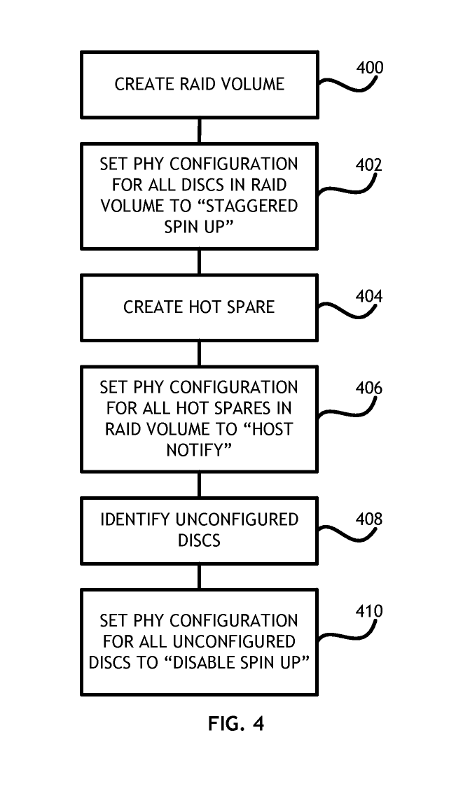

Referring to FIG. 4, a flowchart of a method for configuring a data storage system including components according to at least one embodiment of the present invention is shown. In at least one embodiment, after discovering a system topology, a controller connected to one or more expanders creates 400 one or more redundant array of independent disc volumes from a plurality of discs connected to the one or more expanders. The controller then sets 402 one or more data elements associated with expander PHYs corresponding to such discs in a PHY configuration data structure in the expander to some value indicating that the devices should be spun up at boot time.

In at least one embodiment, the controller creates 404 one or more hot spares from one or more discs connected to the one or more expanders. The controller then sets 406 one or more data elements associated with expander PHYs corresponding to such discs in a PHY configuration data structure in the expander to some value indicating that the devices should not be spun up at boot time, but should be available to spin up based on a command from a host.

In at least one embodiment, the controller identifies 408 one or more unconfigured discs from one or more discs connected to the one or more expanders. The controller then sets 410 one or more data elements associated with expander PHYs corresponding to such discs in a PHY configuration data structure in the expander to some value indicating that the devices should be disabled.

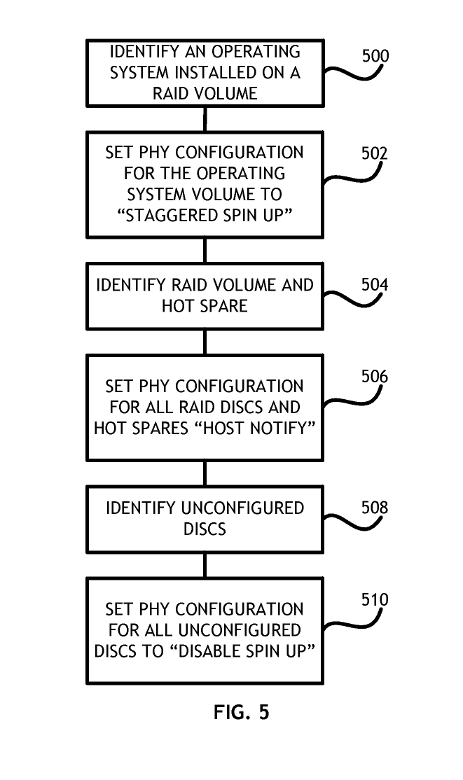

Referring to FIG. 5, a flowchart of another method for configuring a data storage system including components according to at least one embodiment of the present invention is shown. In at least one embodiment, after configuring a redundant array of independent discs, a controller connected to one or more expanders identifies 500 one or more discs containing a host operating system from a plurality of discs connected to the one or more expanders. The controller then sets 502 one or more data elements associated with expander PHYs corresponding to such discs in a PHY configuration data structure in the expander to some value indicating that the devices should be spun up at boot time.

In at least one embodiment, the controller identifies 504 one or more redundant array of independent disc volumes and hot spares from one or more discs connected to the one or more expanders. The controller then sets 506 one or more data elements associated with expander PHYs corresponding to such discs in a PHY configuration data structure in the expander to some value indicating that the devices should not be spun up at boot time, but should be available to spin up based on a command from a host.

In at least one embodiment, the controller identifies 508 one or more unconfigured discs from one or more discs connected to the one or more expanders. The controller then sets 510 one or more data elements associated with expander PHYs corresponding to such discs in a PHY configuration data structure in the expander to some value indicating that the devices should be disabled.

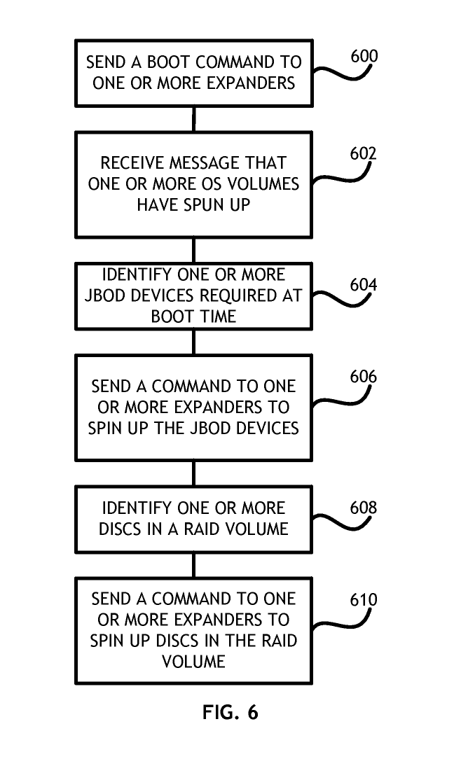

Referring to FIG. 6, a flowchart of another method for configuring a data storage system including components according to at least one embodiment of the present invention is shown. In at least one embodiment, in a data storage system comprising a plurality of discs and corresponding expanders wherein a host operating system is contained on one of the discs, a controller connected to one or more expanders sends 600 a boot command to the one or more expanders. The one or more expanders spin up all devices connected to PHYs designated staggered spin up and sends a spin up complete message to the controller. The controller receives 602 the message from the one or more expanders and the host boots up.

Once the host has booted up, the controller identifies 604 one or more devices connected to the one or more expanders that are required at boot time. The controller then sends 606 one or more commands to the expanders to spin up such required devices.

In at least one embodiment, the controller identifies 608 one or more discs in a redundant array of independent discs volume connected to the one or more expanders. The controller then sends 610 one or more commands to the expanders to spin up discs in the volume.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A controller comprising:
a processor;
memory connected to the processor; and
computer executable program code configured to execute on the processor,
wherein the computer executable program code is configured to:
discover a topology of a data storage system;
designate a first set of discs connected to an expander as critical during boot time;
instruct the expander to configure one or more PHYs corresponding to the first set of discs to spin up at boot time;
designate a second set of discs connected to the expander as non-critical during boot time; and
instruct the expander to configure one or more PHYs corresponding to the second set of discs to refrain from spin up at boot time.

2. The controller of claim 1, wherein the first set of discs corresponds to a redundant array of independent discs volume.

3. The controller of claim 2, wherein the second set of discs corresponds to one or more hot spare discs.

4. The controller of claim 1, wherein the first set of discs corresponds to one or more discs containing a host operating system.

5. The controller of claim 4, wherein the second set of discs corresponds to a redundant array of independent discs volume.

6. The controller of claim 1, wherein the computer executable program code is further configured to:
designate a third set of discs connected to an expander as disabled; and
instruct the expander to configure one or more PHYs corresponding to the third set of discs to disable spin up.

7. The controller of claim 1, wherein the computer executable program code is further configured to instruct the expander to reconfigure a PHY corresponding to a disc in the first set of discs to refrain from spin up at boot time.

8. An expander comprising:
a processor;
a plurality of PHYs, each configured to connect to a data storage device;
memory connected to the processor, configured to store one or more priority configuration values associated with the one or more PHYs; and
computer executable program code configured to execute on the processor,
wherein:
the computer executable program code is configure to:
receive a first priority designation corresponding to a first PHY in the plurality of PHYs;
store the first priority designation corresponding to the first PHY in the memory;
receive a second priority designation corresponding to a second PHY in the plurality of PHYs; and
store the second priority designation corresponding to the second PHY in the memory;
the first priority designation is configured to indicate spin up at boot time; and
the second priority designation is configured to indicate no spin up at boot time.

9. The expander of claim 8, wherein the computer executable program code is further configured to:
receive a third priority designation corresponding to a third PHY in the plurality of PHYs, wherein the third priority designation is configured to indicate disabled spin up; and
store the third priority designation corresponding to the third PHY in the memory.

10. The expander of claim 8, wherein the computer executable program code is further configured to:
receive a signal commanding spin up of a disc connected to the second PHY; and
initiate spin up of the disc connected to the second PHY.

11. The expander of claim 8, wherein the computer executable program code is further configured to:
receive a signal indicating system boot time;
initiate spin up of a disc connected to the first PHY; and
send a signal indicating spin up complete when the disc connected to the first PHY is spun up.

12. The expander of claim 8, wherein the computer executable program code is further configured to:
receive a signal indicating reconfiguration of the first PHY; and
change the first priority designation corresponding to the first PHY to indicate no spin up at boot time.

13. A data storage system comprising:
a host;
a controller associated with the host;
one or more expanders connected to the controller, each of the one or more expanders comprising a PHY configuration data structure configured to designate a boot time spin up priority for one or more PHYs in the expander; and
a plurality of discs, each of the plurality of discs connected to a PHY in the one or more expanders,
wherein:
a first set of discs comprises discs critical at boot time;
a second set of discs comprises discs not critical at boot time;
two or more values in the PHY configuration data structure, each associated with a PHY corresponding to a disc in the first set of discs, are configured to indicate that the discs in the first set of discs should be spun up at a boot time; and
at least one value in the PHY configuration data structure, associated with a PHY corresponding to a disc in the second set of discs, is configured to indicate that the discs in the second set of discs should not be spun up at boot time.

14. The data storage system of claim 13, wherein the first set of discs corresponds to a redundant array of independent discs volume.

15. The data storage system of claim 14, wherein the second set of discs corresponds to one or more hot spare discs.

16. The data storage system of claim 13, wherein the first set of discs corresponds to one or more discs containing a host operating system.

17. The data storage system of claim 16, wherein the second set of discs corresponds to a redundant array of independent discs volume.

18. The data storage system of claim 13, wherein at least one value in the PHY configuration data structure, associated with a PHY corresponding to at least one disc in a third set of discs, is configured to indicate that the spin up of discs in the third set of discs should be disabled.

19. The data storage system of claim 13, wherein the controller is configured to instruct the expander to reconfigure a PHY corresponding to a disc in the first set of discs to refrain from spin up at boot time.

20. The data storage system of claim 13, wherein the expander is configured to:
receive a signal from the controller indicating system boot time;
initiate spin up of discs in the first set of discs; and
send a signal to the controller indicating spin up complete when the first set of discs is spun up.
